(19) United States
(12) Patent Application Publication
(10) Pub. No.: US 2007/0294023 A1
(43) Pub. Date: Dec. 20, 2007

(54) Traffic data collection with probe vehicles

(75) Inventors: Praveen Arcot, Arlington Heights, IL (US); Bishnu Phuyal, Des Plaines, IL (US)

Correspondence Address: NAVTEQ NORTH AMERICA, LLC, 425 West RANDOLPH STREET, SUITE 1200, PATENT DEPT, CHICAGO, IL, 60606, US

(73) Assignee: NAVTEQ NORTH AMERICA, LLC

(21) Appl. No.: 11/455,442

(22) Filed: Jun. 19, 2006

(51) Int. Cl. G08G 1/00; G06F 19/00

(52) U.S. Cl. 701/117

(57) ABSTRACT

A method is disclosed for collecting traffic information using probe vehicles that are driven along roads in a geographic area. In each of the probe vehicles, the vehicle speed and the location reference code that represents that portion of the road network upon which the vehicle is located are determined. The probe vehicle transmits data that indicates the location reference code and the vehicle speed for the location reference code to a central traffic facility.

### BACKGROUND OF THE INVENTION

The present invention relates to collecting traffic data using probe vehicles.

Traffic information systems provide useful data about roads, including data about traffic congestion, delays, traffic incidents, traffic flow, average vehicle speeds, and so on. Traffic information is used by commercial and non-commercial users, including commuters, fleet operators, emergency service providers, etc.

There continues to be a need for more and better traffic information. One factor that affects the ability to provide more and better traffic information relates to improving traffic data collection methods. One way to collect traffic data along roads is to use probe vehicles. A probe vehicle refers to a vehicle that is used for collecting traffic data while being driven on roads for other purposes unrelated to traffic data collection. For example, a probe vehicle may be a vehicle owned by a private individual who uses the vehicle for commuting to work or for leisure activities. Probe vehicles may also include vehicles that are part of a fleet of commercial vehicles, such as delivery trucks that are used to deliver packages. Probe vehicle may also include vehicles used for public transportation, such as buses and taxis.

To use a vehicle as a probe vehicle for traffic data collection, equipment is installed in the vehicle that collects data that indicates the vehicle's location and speed. This equipment in the probe vehicle may operate automatically while the vehicle is being driven. Then, as the vehicle is being used for purposes unrelated to traffic data collection, information about the vehicle's current location and speed is automatically transmitted to the traffic data collection facility. At the traffic data collection facility, the data is analyzed and aggregated with data from other probe vehicles.

Using probe vehicles to collect traffic data provides advantages. For example, collecting traffic data with probe vehicles avoids the cost of permanently installing equipment along roads to measure traffic. In addition, probe vehicles can collect data about the traffic conditions on any road throughout a geographic area. However, there are considerations to be addressed when using probe vehicles to collect traffic information. One consideration associated with using probe vehicles to collect traffic data relates to coverage. A relatively large number of vehicles are needed to be equipped as probes in order to get adequate coverage throughout a geographic region. Another consideration is the cost of communicating the data from the probe vehicles to the traffic data collection facility.

Accordingly, there is room for improvement when using probe vehicles to collect traffic information.

### SUMMARY OF THE INVENTION

To address these and other objectives, the present invention includes a method for collecting traffic information using probe vehicles that are driven along roads in a geographic area. In each of the probe vehicles, the vehicle speed and the location reference code that represents that portion of the road network upon which the vehicle is located are determined. The probe vehicle transmits data that indicates the location reference code and the vehicle speed for the location reference code to a central traffic facility.

### BRIEF DESCRIPTION OF THE DRAWINGS

FIG. 1 is an illustration of a geographic area including a road network and a traffic information system.

FIG. 2 shows how location reference codes used by the traffic information system in FIG. 1 are assigned along a portion of a road.

FIG. 3 is a block diagram showing components of the traffic message shown in FIG. 1.

FIG. 4 is a block diagram of a navigation system in one of the probe vehicles in FIG. 1.

FIG. 5 is a flowchart showing steps in a process performed by the probe vehicle in FIG. 4.

### DETAILED DESCRIPTION OF THE PRESENTLY PREFERRED EMBODIMENTS

### I. Traffic Broadcast System—Overview

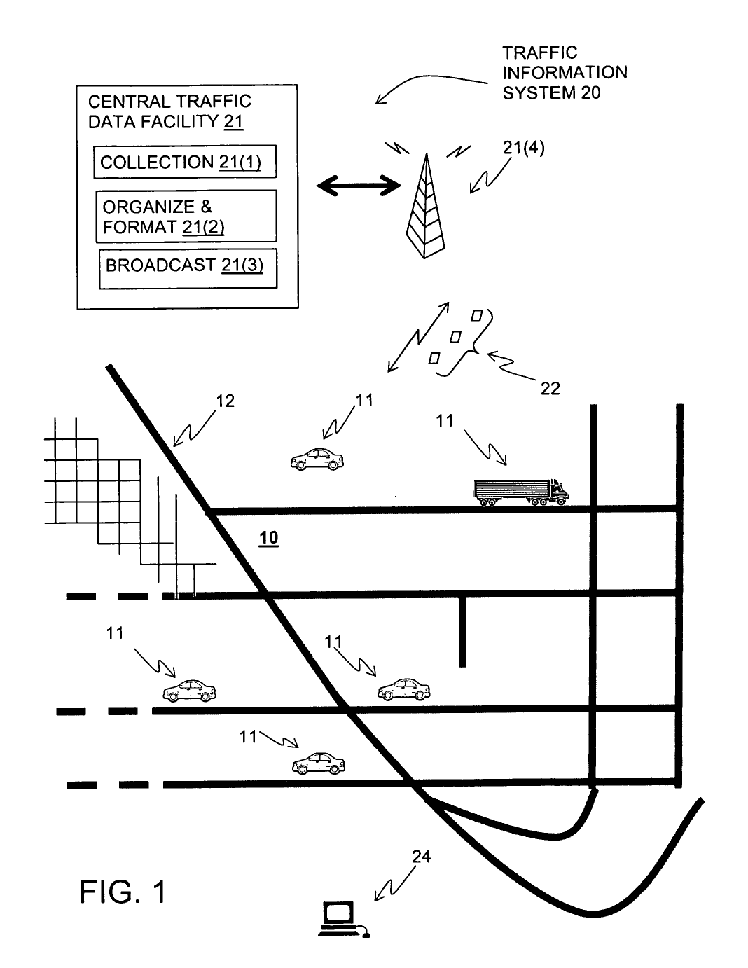

FIG. 1 is diagram illustrating a geographic region 10. The geographic region 10 may be a metropolitan area, such as the New York metropolitan area, the Los Angeles metropolitan area, or any other metropolitan area. Alternatively, the geographic region 10 may be a state, province, or country, such as California, Illinois, France, England, or Germany. Alternatively, the geographic region 10 can be a combination of one or more metropolitan areas, states, countries and so on.

Vehicles 11 travel on a road network 12 in the geographic region 10. The vehicles 11 may include cars, trucks, buses, bicycles, motorcycles, etc. In this embodiment, some of the vehicles 11 include suitable equipment that enables them to act as probe vehicles for traffic data collection.

A traffic information system 20 is located in the geographic region 10. The traffic information system 20 provides for the collection of data relating to traffic and road conditions, the analysis and organization of this collected data, the formatting of the analyzed data into traffic messages, and the transmission of these traffic messages to the vehicles 11 in the region 10 on a regular and continuing basis.

The traffic information system 20 includes a central traffic data processing facility 21. The central traffic data processing facility 21 may be operated by a government organization or may be privately operated.

The central traffic data processing facility 21 includes suitable equipment and programming 21(1) for collecting the data relating to traffic conditions from the vehicles that are equipped as probes. This equipment and programming 21(1) include, for example, various communications links (including wireless links), receivers, data storage devices, programming that saves the collected data, programming that logs data collection times and locations, and so on. The central traffic data processing facility 21 may use various means in addition to probe vehicles to obtain information about traffic and road conditions.

The central traffic data processing facility 21 includes equipment and programming 21(2) for assembling, organizing, analyzing and formatting the collected traffic and road condition data. This programming and equipment 21(2) include storage devices, programming that statistically analyzes the collected data for potential errors, programming that organizes the collected data, and programming that uses the data to prepare messages in one or more appropriate predetermined formats.

The central traffic data processing facility 21 also includes suitable equipment and programming 21(3) for transmitting or broadcasting the data messages. The equipment and programming 21(3) include interfaces to transmitters, programming that communicates formatted messages at regular intervals to the transmitters, and so on. The central traffic data processing facility 21 may also include transmission equipment 21(4). This equipment 21(4) may comprise one or more satellites, FM transmitters, including antennas, towers, or other wireless transmitters. This equipment 21(4) provides for broadcasting or transmitting the formatted traffic and road condition data messages 22 throughout the region 10. The transmission equipment 21(4) may be part of the traffic information system 20, or alternatively, the transmission equipment 21(4) may use other systems, such as cellular or paging systems, satellites, FM radio stations, and so on, to transmit traffic data messages 22 to the vehicles 11 and non-vehicles 24 in the region 10.

Some of the vehicles 11 include suitable equipment that enables them to receive the traffic data transmitted by the traffic information system 20.

There are various types of traffic information systems and traffic message formats. In the embodiment in FIG. 1, the traffic information system 20 conforms to the RDS-TMC system. In the RDS-TMC system, the messages conform to the ALERT-C format. In the RDS-TMC system, many primary and some secondary road interchanges have predefined location numbers. These location numbers are a part of the traffic messages that are broadcast. These location numbers are assigned by the road authorities, map developer, or other parties involved in the development and maintenance of the RDS-TMC system. These location numbers are standardized for all users. That is, any receiver that uses the messages from the traffic broadcast system is required to be able to relate the location reference numbers in the RDS-TMC messages to the known locations to which the numbers are assigned.

In places where these types of location numbers are assigned, the location reference numbers may be unique within a regional database of the specific traffic broadcast system. Such a regional database is known as a location table. A separate location table is defined for each different region. This location table region may correspond to the region 10 in FIG. 1.

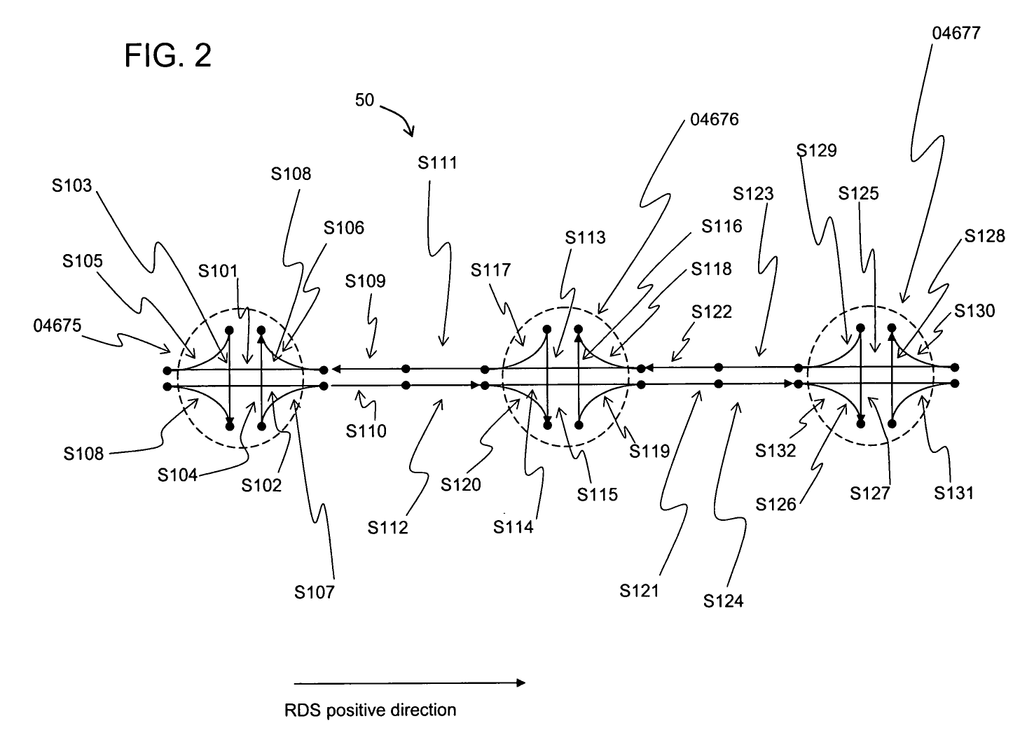

FIG. 2 shows one example of how location reference numbers are assigned. The example of a location referencing system in FIG. 2 is similar or identical to the RDS-TMC system. FIG. 2 illustrates a portion of a roadway 50. This roadway 50 is one of the roadways in the roadway network 12 (in FIG. 1) about which the traffic information system 20 monitors traffic and about which the traffic information system 20 reports on traffic congestion by means of traffic messages 22.

Referring to FIG. 2, in order to identify locations along the roadway 50 to which II the traffic message pertains, location reference numbers (e.g., 04675, 04676, and 04677) are assigned to locations along the roadway 50. These location reference numbers are pre-assigned by the road authorities or others involved with the traffic broadcast system 20. The messages 22 (in FIG. 1) broadcast by the traffic information system 20 include these location reference numbers when identifying locations of traffic flow.

In current traffic information systems, the roads about which traffic messages are transmitted are major roads, such as expressways or major arterial roads. In current traffic information systems, traffic data along minor roads is not collected or reported. In the future, traffic information systems may collect and report traffic data for minor roads, as well as major roads. Accordingly, in systems, such as the traffic information system 20 in FIG. 1, location reference numbers are assigned to locations along expressways, major arterial roads, and minor roads.

FIG. 2 shows only three location numbers, 04675, 04676, and 04677. It is understood that in a typical traffic broadcast system, there may be hundreds, thousands, or more, of location reference numbers assigned to locations along roads in each region represented by a location table. As shown in FIG. 2, the location reference numbers correspond to interchanges along the roadway 50. However, location reference numbers may be assigned to any position along the roadway 500, including positions between interchanges.

In the location referencing system in FIG. 2, directions may be defined as positive or negative. For example, in the RDS-TMC system, the direction is positive for travel directions west to east and from south to north. The location reference numbers may be, but are not necessarily, assigned in consecutive order along a roadway.

In the location referencing system in FIG. 2, each roadway is assigned its own location reference numbers. The location reference numbers of one roadway are not shared with other roadways. Therefore, at an interchange between two roadways each of which is assigned location reference numbers, one location reference number is assigned to the interchange for the first of the roadways and a second different location reference number is assigned to the same interchange for the second of the roadways. Thus, a single interchange may have two or more location reference numbers assigned to it, one for each of the roadways that meet at the interchange.

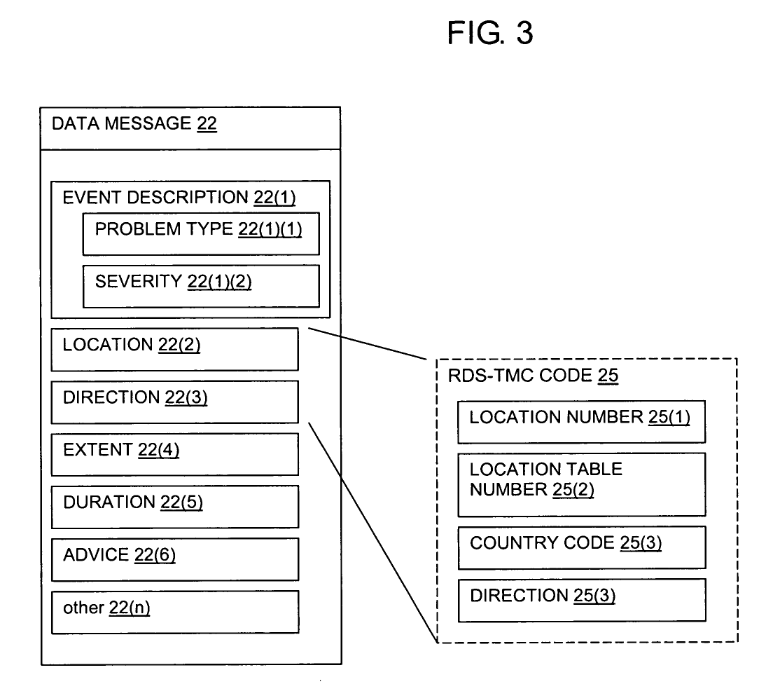

FIG. 3 illustrates the data components of one of the traffic messages 22. The traffic message 22 can include various kinds of information. In FIG. 3, the traffic message 22 includes data components that identify one or more locations along a road, what the traffic conditions are at these locations, and how far the identified traffic condition extends.

In the embodiment shown in FIG. 3, the traffic message 22 includes the following data components: an event description 22(1), a location 22(2), a direction 22(3), an extent 22(4), a duration 22(5) and advice 22(6). In alternative embodiments, the traffic message 22 may also include components that provide other information 22(n).

The event description component 22(1) includes data that describe a traffic problem 22(1)(1) along with data that describe a level of severity 22(1)(2) of the traffic problem 22(1)(1).

The location component 22(2) includes a reference number that identifies the location (e.g., a primary location) of the traffic problem 22(1)(1).

The direction component 22(3) includes data that indicate the direction of traffic affected.

The extent component 22(4) includes data that identify a length of a traffic congestion queue with respect to the location 22(2). The extent component 22(4) implicitly defines another location (e.g., a secondary location) straddling the traffic condition in terms of the number of location references in between.

The advice component 22(6) provides a recommendation for a diversion of route.

According to one embodiment, the traffic message 22 conforms to the standard format for ALERT-C messages established in the RDS-TMC system. For example, in the RDS-TMC system, the location 22(2) portion of the message 22 includes a RDS-TMC code 25. The RDS-TMC code 25 includes a location number 25(1), a location table number 25(2), a country code 25(3), and a direction 25(4). The location number 25(1) is a unique number within a region to which one location table (i.e., a database of numbers) corresponds. The location table number 25(2) is a unique number assigned to each separate location table. The country code 25(3) is a number that identifies the country in which the location referenced by the location number 25(1) is located. The direction 25(4) takes into account factors such as bi-directionality and II whether or not the segments are external to the junction. The RDS-TMC code 25 is published in the message 22 in a string as follows:
ABCCDEEEEE

where:

A: Direction of the road segment (=direction 25(4))

B: Country code (=country code 25(3))

CC: Location database number (=location table number 25(2))

D: RDS direction (+,−, P, N) (=direction 25(4))

EEEEE: Location code (=location number 25(1))

By convention, the location portion 22(2) of a message 22 specifies the location at which a traffic queue begins. This location may be referred to as the primary location or the head. The message 22 also indicates a secondary location or tail. The message 22 indicates the secondary location indirectly, i.e., by means of the direction and extent 22(4). The extent 22(4) indicates how many location codes from the primary location are affected at the level of severity (i.e., 22(1)(2)) indicated in the message.

Location codes refer to specific locations that are spaced apart from each other along a road. Therefore, when using location codes to specify a primary location (i.e., the location at which traffic congestion begins), the exact location at which traffic congestion begins may be between the locations to which location codes are assigned. In this case, by convention, the location code assigned to the location immediately beyond the traffic incident is used to specify the primary location.

As stated above, some of the vehicles 11 (in FIG. 1) have appropriate equipment that can receive these traffic messages 22. The data in these traffic messages may be used in the vehicle in various ways. For example, the information may be presented to the vehicle driver. Alternatively, the information in these traffic messages may be used in conjunction with a navigation system, as described in U.S. Pat. No. 6,438,561.

### II. Collection of Traffic Data with Probe Vehicles

### A. First Probe Vehicle Embodiment

In one embodiment, the traffic information system 20 in FIG. 1 collects traffic data using vehicles equipped with navigation systems as probe vehicles. Referring to FIG. 1, some of the vehicles 11 are equipped with the necessary hardware, software and data in order to serve as probe vehicles for traffic data collection. As each of the probe vehicles 11 moves on the roads (or is stopped) in the geographic area 10, the data collection equipment in the vehicle 11 collects traffic data, as explained in more detail below. These vehicles 11 used as probe vehicles may include vehicles which are owned (or leased) by private parties or commercial entities, as well as fleet vehicles.

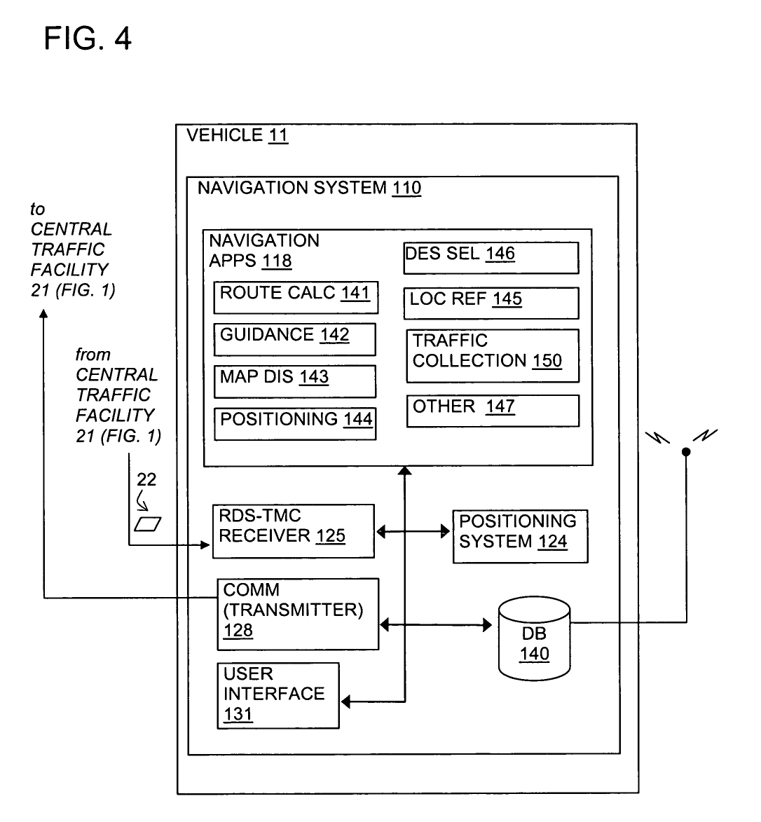

FIG. 4 shows components of one of the vehicles 11 of FIG. 1 that is used as a probe vehicle for traffic data collection. As mentioned above, the vehicle 11 may be a car or truck. Installed in the vehicle 11 is a navigation system 110. The navigation system 110 is a combination of hardware, software and data components. The navigation system 110 includes a positioning system 124. The positioning system 124 may utilize GPS technology, a dead reckoning-type system, or combinations of these, or other systems, all of which are known in the art. The positioning system 124 may include suitable sensing devices that measure the traveling distance speed, direction, and so on, of the vehicle and appropriate technology to obtain a GPS signal, in a manner which is known in the art.

In this embodiment, the vehicle 11 includes a traffic message receiver 125. The receiver 125 is a wireless receiver capable of receiving the traffic messages 22 from the traffic information system 20. (Various different wireless technologies may be used including satellite transmission, FM transmission, cellular, WiFi, etc.) The receiver 125 outputs to the appropriate application(s) 118 in the navigation system 110 in order to utilize the data transmitted by the traffic information system 20 when performing navigation functions.

The vehicle 11 includes a wireless data transmitter 128. The wireless data transmitter may be part of the navigation system 110 or may be a separate component. The wireless data transmitter 128 is capable of sending data messages to the central traffic data facility 21 over a data communications network, at least a part of which is a wireless communications network. The wireless data transmitter 128 may utilize any suitable technology for sending messages, such as cellular, satellite, Wimax, DSRC, etc.

The navigation system 110 also includes a user interface 131. The user interface 131 includes appropriate equipment that allows the end user (e.g., the driver or passengers) to input information into and receive information from the navigation system 110.

The navigation system 110 includes navigation application software 118. The navigation application software 118 uses a map database 140 in conjunction with the outputs from the positioning system 124 and the receiver 125, to provide various navigation features and functions. Among the functions provided by the navigation applications 118 are route calculation 141 (wherein a route to a destination identified by the end-user is determined), route guidance 142 (wherein detailed directions are provided for reaching a desired destination), map display 143, vehicle positioning 144 (e.g., map matching), and destination selection 146. Also included among the applications 118 on the navigation system 110 is a location referencing application 145, which receives traffic data messages 22 from the traffic data message receiver 125, extracts pertinent data from the traffic data messages 22, and applies the extracted data appropriately for use with other navigation applications.

In this embodiment, the navigation system 110 includes a traffic data collection application 150. Operation of the traffic data collection application 150 is explained in more detail below.

Other functions and programming 147 may be included among the applications 118 in the navigation system 110.

### B. The Map Database

As stated above, the navigation system 110 uses a map database 140. The map database 140 is stored on a storage medium. The map database 140 contains information about geographic features, including roads, in the region 10 (in FIG. 1).

For purposes of representation in the geographic database 140, each road in the geographic region 10 is regarded as being composed of one or more segments. Each road segment is associated with two nodes: one node represents the point at one end of the road segment and the other node represents the point at the other end of the road segment. The node at either end of a road segment may correspond to a location at which the road meets another road, e.g., an intersection, or where the road dead ends.

In the geographic database 140, there is at least one database entry (also referred to as “entity” or “record”) for each road segment represented in the geographic region 10. This road segment data record may have associated with it information (such as “attributes”, “fields”, etc.) that allows identification of the nodes associated with the road segment and/or the geographic positions (e.g., the latitude and longitude coordinates) of the two nodes. In addition, the road segment record may have associated with it information (e.g., more “attributes”, “fields”, etc.), that specify the speed of travel on the portion of the roadway represented by the road segment record, the direction of travel permitted on the road portion represented by the road segment record, what if any turn restrictions exist at each of the nodes which correspond to intersections at the ends of the road portion represented by the road segment record, the street address ranges of the roadway portion represented by the road segment record, the name of the road, and so on. A road segment data record that represents an other-than-straight road segment may include one or more shape point data attributes that define the other-than-straight shape of the road segment. The various attributes associated with a road segment may be included in a single road segment record, or are included in more than one type of road segment record which are cross-referenced to each other.

In a geographic database that represents the region 10, there may also be a database entry (entity or record) for each node in the geographic region. The node data record may have associated with it information (such as “attributes”, “fields”, etc.) that allows identification of the road segment(s) that connect to it and/or its geographic position (e.g., its latitude and longitude coordinates).

According to one embodiment, the geographic database includes data that relates road segments to the location reference codes. This information enables the vehicle that uses the geographic database to operate as a probe vehicle for traffic data collection purposes.

As stated above, traffic information systems may assign specific reference codes to locations in the geographic region about which the traffic messages relate. Traffic information systems, such as the RDS-TMC system, use these reference codes instead of the actual location names in traffic messages.

Referring to FIG. 2, there maybe multiple segments, S101, S102, . . . S132, of the roadway 50 associated with each location along the roadway 50 to which a location reference number (e.g., 04675, 04676 . . . ) has been assigned. As stated above, each of these multiple segments of the roadway 50 may be represented by at least one record in the geographic database 140. Moreover, as illustrated by FIG. 2, there may also be several segments of the roadway 50 located between the interchanges along the roadway 50 to which location reference numbers have been assigned. Each of these segments of the roadway 50 between interchanges may be represented by at least one record in the geographic database 140.

In order to enable the vehicle to operate as a probe vehicle for traffic data collection, a means is provided that relates road segments (e.g., road segment records) to location reference numbers. There are several different ways this can be accomplished. One way is to identify the location reference code to which a road segment relates as an attribute of the road segment data record that represents that road segment. Where there are several road segments leading into a location to which a location reference code has been assigned, the road segment records that represent each of these road segments would each include an attribute that identifies the location reference code. (In cases where a single road segment record represents traffic that flows in both directions, separate attributes may be included for each direction.). Another way to provide this function is to use an index, e.g., that relates road segment IDs to location reference codes. (Again, if an index is used, a means is provided to account for direction of travel in cases where a single road segment record represents a road segment on which traffic flows in both directions.) Other ways of relating road segments to location reference codes may be provided and any suitable means of associating road segments with location reference codes may be used.

Note that if the navigation system in the vehicle supports receiving traffic data messages and using the data in the traffic data messages in connection with navigation-related functions, the geographic database 140 also includes data that relates location reference codes to road segments. One way in which the geographic database may include data that relates location reference codes to road segments is disclosed in U.S. Pat. No. 6,438,561, the entire disclosure of which is incorporated by reference herein. (Note that this type of data may be different from the data used by the vehicle for collection of traffic data as a probe vehicle.)

### C. Traffic Data Collection

As stated above, some of the vehicles 11 are equipped to act as probe vehicles for traffic data collection. In this embodiment, the navigation system 110 in a vehicle 11 operating as a probe vehicle includes the traffic data collection application 150 that enables the vehicle to serve this function. The traffic data collection application 150 uses some of the same hardware, software and data components of the navigation system 110 that are used for providing other navigation-related features. The traffic data collection application 150 may operate in the background, i.e., without the need for the vehicle operator to start or control the application.

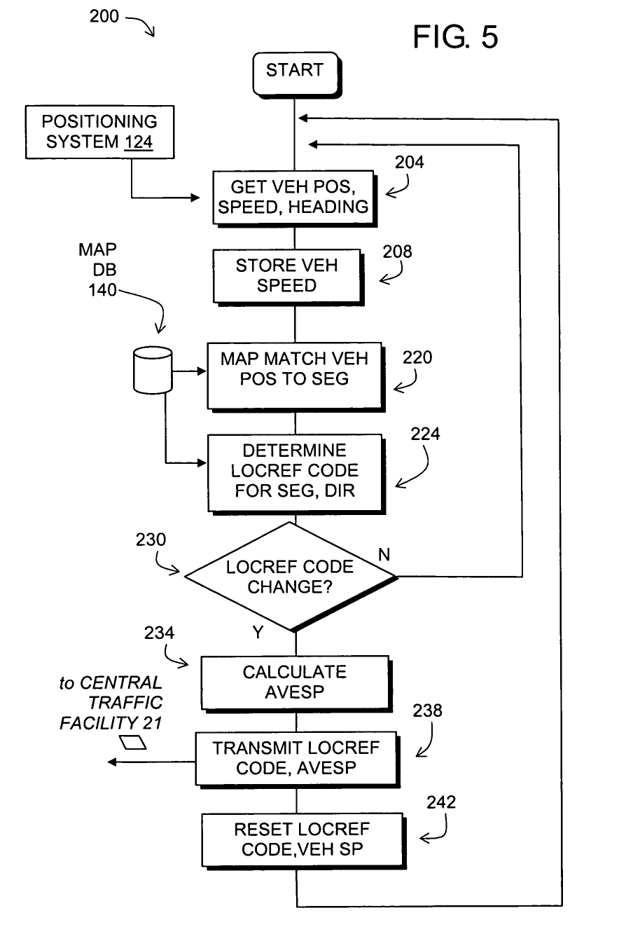

FIG. 5 shows a flowchart of a process 200 performed by the traffic data collection application 150. In an initial step, data that indicates the vehicle position and speed are obtained (Step 204). The traffic data collection application 150 may obtain data that indicates the vehicle position from the positioning system 124. The vehicle position may be expressed in any suitable manner, such as geographic coordinates (e.g., latitude and longitude). The vehicle speed may be expressed in any suitable manner, such as miles per hour.

The data that indicates the vehicle speed is stored temporarily (Step 208).

Next, the road segment upon which the vehicle is located is determined (Step 220). The traffic data collection application 150 uses the geographic database 140 for this purpose, i.e., by map matching. (Note that in many vehicle navigation systems, map matching is being performed continuously to support the navigation-related functions so that this information is readily available already.) When determining the road segment on which the vehicle is located, the direction that the vehicle is traveling along the road segment is also determined.

Then, the traffic data collection application 150 determines which location reference code, if any, represents the road segment and direction that the vehicle is located on (Step 224). As mentioned above in connection with FIG. 2, location reference codes may not be assigned for all the roads in a geographic region. Thus, if the vehicle is on a road along which location reference codes have not been assigned, there is no location reference code to determine. On the other hand, if the vehicle is on a road along which location reference codes have been assigned, the traffic data collection application 150 determines the location reference code that represents the vehicle's current position and direction.

Next, the traffic data collection application 150 determines whether the vehicle has just left that portion of the road network that is represented by a single location reference code (Step 230). One way to perform this step is to determine whether the location reference code has changed, i.e., by comparing the location reference code that has just been determined to the location reference code that had been determined for the previous vehicle position. If the vehicle is still on the portion of road represented by the same location reference code, the traffic data collection application 150 loops back to the step where the vehicle position and speed are obtained (Step 204). When the step of storing the vehicle speed (Step 208) is performed this next time, the data indicating the new vehicle speed is stored separately from the data indicating the prior vehicle speed. That is, data indicating the new vehicle speed is stored each time the process 200 loops back while the vehicle is on a portion of road represented by the same location reference code.

When the vehicle position has changed so that it is no longer on the portion of road represented by the prior location reference code (Step 230), the data collection application 150 determines the average vehicle speed for when it was on the portion of road represented by the prior location reference code (Step 234). In this embodiment, the average vehicle speed may be determined by averaging the vehicle speeds that had been stored (in Step 208) each time the vehicle position was determined to be located on the portion of road represented by the same location reference code. The number of times the vehicle is determined to be located on the portion of road represented by the same location reference code may vary depending on several factors, such as the vehicle speed, how far apart the locations assigned location reference codes are, how frequently the navigation system obtains a new vehicle position, and other factors.

Once the average vehicle speed is determined, the data collection application 150 transmits data that indicates the average vehicle speed and the location reference code to the traffic information provider 21 (Step 238). The data collection application 150 may use the communication system 128 for this purpose.

Then, the process 200 resets (clears) the stored vehicle speed data and the current location reference code (Step 242). The process 200 loops back to the step of obtaining the vehicle position and speed (Step 204). The process 200 continues to perform the steps for determining an average vehicle speed for a new location reference code.

At the traffic information provider 21, the data message that indicates the vehicle speed and location reference code is received from the probe vehicle. This data is used in combination with data received from other probe vehicles to determine average vehicle speeds for some or all location codes located throughout the geographic region 10. This information may then be transmitted out to the vehicles 11, including vehicles not used as probes.

### D. Other Embodiments

In the embodiment disclosed above, it was described how vehicles with navigation systems could be used as probe vehicles for traffic data collection. In an alternative embodiment, vehicles without navigation systems may be used as probes for traffic data collection purposes. According to this alternative, a vehicle may be equipped with the necessary hardware, software and data in order to perform the function of being a probe for traffic data collection, but not other navigation-related functions. For example, a vehicle equipped to serve as a probe for traffic data collection may be equipped with a positioning system, a data transmitter, data collection software (including vehicle positioning and map matching software), and at least portions of a map database. Probe vehicles equipped in this manner would operate in a manner similar to the way described in connection with the first embodiment.

A probe vehicle for traffic data collection that does not provide other navigation-related functions may use an abridged version of a geographic database that represents only those roads in a geographic area to which location reference codes have been assigned. This abridged version of a geographic database may represent the portions of roads associated with a location reference code as being composed of individual road segments or alternatively, this abridged version of a geographic database may aggregate the individual road segments associated with each location reference code into a single extended segment.

In the first traffic collection embodiment disclosed above, it was described how a message was sent to the central traffic facility from the probe vehicle indicating the location reference code and the average vehicle speed when the probe vehicle left the portion of road represented by the location reference code. In an alternative embodiment, the probe vehicle may transmit a message to the central traffic facility at other times or periods. For example, the probe vehicle may transmit data indicating the vehicle speed and location reference code each time the vehicle position is determined. Although this alternative may increase the number of messages sent by the probe vehicle relative to the first disclosed method, this alternative still affords advantages relative to the prior art. According to another alternative, the probe vehicle may pre-filter the data by sending data indicating an average vehicle speed and location reference code only when the average vehicle speed deviates significantly from a predetermined normal speed for the roadway.

The disclosed embodiments may be used with traffic information systems that convey traffic information in data messages that indicate the traffic conditions relative to locations along the road network that are designated by location reference codes. An example of such a traffic information system is the RDS-TMC system in which traffic data messages conform to the ALERT-C format. However, the disclosed embodiments are not limited to use with any particular type of traffic information system or message format. More information about navigation systems, geographic data, and traffic message systems is included in U.S. Pat. No. 6,438,561, the entire disclosure of which is incorporated by reference herein.

Some of the steps in the process 200 (in FIG. 5) for traffic data collection are similar or identical to steps performed by the navigation system 110 when performing navigation-related functions. For example, the step of determining which road segment the vehicle is on (Step 220 in FIG. 5) is also performed by the vehicle positioning application (144 in FIG. 4) for purposes of determining an origin for a route or when determining where to indicate the vehicle position on a map display. Accordingly, the II data collection application 150 may not need to perform this step independently, but instead may share common routines and data with other navigation-related applications 118.

### E. Further Considerations

One of the advantages provided by the disclosed embodiments is that map matching performed in each vehicle being used as a probe may be more accurate than map matching performed on a remotely located traffic information server.

Another advantage provided by the disclosed embodiments is that a relatively small amount of data is transferred from the probe vehicle to the central traffic facility collection facility 21. The amount of data that is sent to the central traffic facility is also reduced because the probe vehicle need not transmit vehicle speed data if it is not on a road represented by a location reference code.

Still another advantage provided by the disclosed embodiments is that a significant portion of data computation is performed at the probe vehicle level, hence these probe vehicles serve as distributed computers, performing tasks otherwise performed at the central computer.

Another advantage of the disclosed embodiments is that a significant portion of the data computation done in a probe vehicle for traffic data collection purposes is already being done anyway for navigation-related purposes.

Yet another advantage of the disclosed embodiments is that the privacy of the vehicle operator may be preserved. With the disclosed embodiments, the identity of the probe vehicle may be kept anonymous easily. Prior probe vehicle collection systems require information that identifies the probe vehicle because map matching is done on the traffic information server. With the disclosed embodiments, the probe vehicle needs to send only the location reference code and average vehicle speed, so therefore the privacy of the probe vehicle can easily be maintained.

It is intended that the foregoing detailed description be regarded as illustrative rather than limiting and that it is understood that the following claims including all equivalents are intended to define the scope of the invention.

We claim:

1. A method of collecting traffic information comprising:
in each one of a plurality of vehicles being driven along roads in a geographic area;
determining which location reference code represents that portion of the road network upon which the vehicle located;
determining a vehicle speed; and
transmitting data that indicates the location reference code and the vehicle speed from the vehicle to a central traffic facility.

2. The method of claim 1 wherein the location reference code is used in traffic messages conforming to the ALERT-C format.

3. The method of claim 1 wherein the data transmitted from the vehicle to the central traffic facility does not require identifying the vehicle.

4. The method of claim 1 further comprising the step of:
in each one of a plurality of vehicles being driven along roads in a geographic area, prior to the step of determining which location reference code represents that portion of the road network upon which the vehicle located, determining a vehicle position.

5. The method of claim 4 wherein the vehicle position is determined using a GPS unit.

6. The method of claim 1 further comprising the step of:
in each one of a plurality of vehicles being driven along roads in a geographic area, prior to the step of determining which location reference code represents that portion of the road network upon which the vehicle located, determining which road segment the vehicle is located on.

7. The method of claim 1 wherein the step of determining which location reference code represents that portion of the road network upon which the vehicle located further comprises:
determining which road segment the vehicle is located on; and
determining which location reference code represents that portion of the road network that includes the road segment the vehicle is located on.

8. The method of claim 7 wherein the step of determining which location reference code represents that portion of the road network that includes the road segment the vehicle is located on is performed using a geographic database.

9. The method of claim 1 wherein the steps of determining which location reference code represents that portion of the road network upon which the vehicle located and transmitting data that indicates the location reference code and the vehicle speed from the vehicle to a central traffic facility are performed without involvement of a vehicle driver.

10. The method of claim 1 wherein at least some of the plurality of vehicles include navigation systems that provide navigation-related features to drivers of the vehicles.

11. The method of claim 1 wherein some of the plurality of vehicles do not provide navigation-related features to drivers of the vehicles.

12. The method of claim 1 wherein the vehicle speed is an average vehicle speed.

13. The method of claim 12 wherein the average vehicle speed is determined by averaging all the vehicle speed data readings obtained while the vehicle was determined to be that portion of the road network represented by the same location reference code.

14. The method of claim 1 wherein the step of transmitting is performed after determining that the vehicle has traveled onto a portion of the road network represented by another location reference code.

15. The method of claim 1 wherein the location reference code represents a point along the road network in a single direction of travel.

16. A navigation system used in a vehicle comprising:
a positioning system;
a geographic database;
navigation applications that use the geographic database and data from the positioning system to provide route guidance to a driver of the vehicle;
data transmission equipment operable for transmitting data messages from the vehicle over a network to a central traffic data facility; and
a data collection application that uses data in the geographic database to determine a vehicle speed and an associated location reference code and transmit the vehicle speed and associated location reference code to the central traffic data facility.

17. A probe vehicle for collecting traffic data comprising:
a positioning system installed in the probe vehicle;
a geographic database;
data transmission equipment operable for transmitting data from the probe vehicle over a network to a central traffic data facility; and
a data collection application that uses data in the geographic database to determine a vehicle speed and an associated location reference code and transmit the vehicle speed and associated location reference code to the central traffic data facility.

18. The probe vehicle of claim 17 further comprising:
a navigation system installed in the probe vehicle that uses the geographic database to provide navigation-related features to a driver.

19. A geographic database used in a probe vehicle for traffic data collection comprising:
data that represents road segments in a geographic area; and
data that relates road segments to location reference codes used in traffic messages.
